(19) United States
(12) Patent Application Publication
(10) Pub. No.: US 2005/0064109 A1
(43) Pub. Date: Mar. 24, 2005

(54) Method of forming an ultrathin nitride/oxide stack as a gate dielectric

(75) Inventors: Chi-Chun Chen, Kaohsing (TW); Tze-Liang Lee, Hsinchu (TW); Shih-Chang Chen, Hsin-Chu (TW)

Correspondence Address: HAYNES AND BOONE, LLP, 901 MAIN STREET, SUITE 3100, DALLAS, TX, 75202, US

(73) Assignee: Taiwan Semiconductor Manufacturing Co.

(21) Appl. No.: 10/666,359

(22) Filed: Sep. 19, 2003

(51) Int. Cl. H05H 1/24

(52) U.S. Cl. 427/569

(57) ABSTRACT

A method of forming a final stacked gate dielectric comprising the following steps. A substrate is provided and an oxide layer is formed upon the substrate. A nitride layer is formed upon the oxide layer. The oxide layer and the nitride layer comprising an initial stacked gate dielectric. The initial stacked gate dielectric is subjected to a plasma nitridation process under an N-containing ambient to form an intermediate stacked gate dielectric. The intermediate stacked gate dielectric is subjected to a plasma reoxidation process to form the final stacked gate dielectric.

### FIELD OF THE INVENTION

The present invention relates generally to semiconductor fabrication and more specifically to fabrication of gate dielectrics.

### BACKGROUND OF THE INVENTION

Ultrathin, i.e. less than about 40 Å, nitride/oxide stacks are very promising for gate dielectrics in sub-0.1 μm metal-oxide semiconductor (MOS) devices.

Formation of conventional nitride/oxide stacks consists of four processes. First, a thermal oxide (SiO₂) or oxynitride (SiON) layer is grown as an interfacial layer. Second, a thin chemical vapor deposition (CVD) nitride layer is deposited using either a rapid thermal CVD (RTCVD) process or a remote plasma enhanced (RPE) CVD process. Third, a high temperature NH₃ anneal is conducted at a temperature of from about 700 to 900° C. to ensure nitride film stoichiometric. Finally, a high temperature reoxidation process is conducted at a temperature of from about 800 to 1000° C. using nitric gas (N₂O or NO) to repair trapping in the nitride layer.

This four step conventional integrated process generates a nitride/oxide film stack which has a thicker physically but a smaller equivalent oxide thickness (EOT) due to the higher dielectric constant (k) (about 7.8) of the nitride layer. Therefore a significant reduction in gate leakage current is achieved.

However, this four step conventional integrated process is complicated, in part due the temperature ramp-up before the annealing steps and the temperature ramp-down after the annealing steps, and the thermal budget is kept high due to the necessity of the annealing steps.

U.S. Pat. No. 6,228,779 B1 to Bloom et al. describes an SiON and ON stack gate dielectric high pressure process.

U.S. Pat. No. 6,017,791 to Wang et al. describes an ON process for a gate dielectric.

U.S. Pat. No. 6,020,238 to He et al. describes a high-k (high dielectric constant) gate dielectric process for a low voltage non-volatile memory.

U.S. Pat. No. 5,464,792 to Tseng et al. describes a process to incorporate nitrogen at an interface of a dielectric layer in a semiconductor device.

### SUMMARY OF THE INVENTION

Accordingly, it is an object of one or more embodiments of the present invention to provide an improved method of

Other objects will appear hereinafter.

It has now been discovered that the above and other objects of the present invention may be accomplished in the following manner. Specifically, a substrate is provided and an oxide layer is formed upon the substrate. A nitride layer is formed upon the oxide layer. The oxide layer and the nitride layer comprising an initial stacked gate dielectric. The initial stacked gate dielectric is subjected to a plasma nitridation process under an N-containing ambient to form an intermediate stacked gate dielectric. The intermediate stacked gate dielectric is subjected to a plasma reoxidation process to form the final stacked gate dielectric.

### BRIEF DESCRIPTION OF THE DRAWINGS

The present invention will be more clearly understood from the following description taken in conjunction with the accompanying drawings in which like reference numerals designate similar or corresponding elements, regions and portions and in which:

FIGS. 1 to 4 schematically illustrate a preferred embodiment of the present invention.

FIG. 5 is a graph of the electrical performance of the stacked gate dielectric fabricated in accordance with the present invention.

### DETAILED DESCRIPTION OF THE PREFERRED EMBODIMENT

Initial Structure

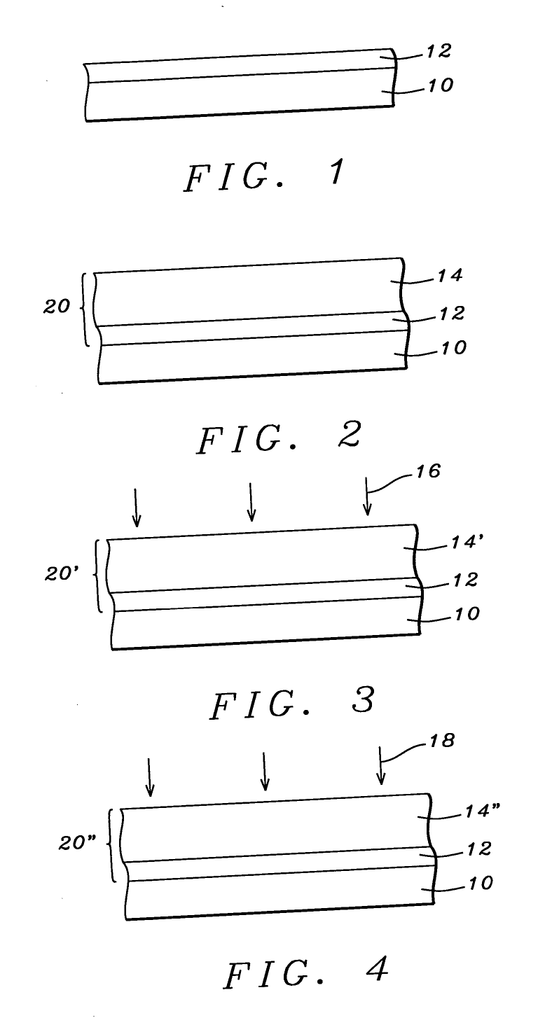

As shown in FIG. 1, silicon substrate 10 is subjected to a thermal oxidation process to form a thermal silicon oxide (thermal oxide) layer 12 having a thickness of preferably from about 3 to 15 Å and more preferably from about 5 to 10 Å. Thermal oxide layer 12 is formed at a temperature of preferably from about 600 to 700° C. and more preferably from about 625 to 675° C.

Thermal oxide layer 12 may also be thermal silicon oxynitride (thermal oxynitride) having a thickness of preferably from about 3 to 15 Å and more preferably from about 5 to 10 Å. Thermal oxynitride layer 12 is formed at a temperature of preferably from about 700 to 900° C. and more preferably from about 750 to 850° C.

Formation of Silicon Nitride Layer 14

As shown in FIG. 2, a silicon nitride (nitride) layer 14 is formed over thermal oxide layer 12 to a thickness of preferably from about 5 to 30 Å and more preferably from about 5 to 15 Å using either an RTCVD process or a RPECVD process. Nitride layer 14 is formed at a temperature of preferably from about 500 to 700° C. and more preferably from about 550 to 650° C.

Nitride layer 14 and thermal oxide layer 12 comprise initial stacked gate dielectric 20.

Plasma Nitridation Process 16

As shown in FIG. 3, the stacked gate dielectric 20 is subjected to a plasma nitridation process 16 in the presence of an N-containing gas (such as N₂) at a temperature of preferably from about 300 to 700° C. and more preferably from about 350 to 650° C., and at a pressure of preferably from about 10 mTorr to 10 Torr and more preferably from about 20 mTorr to 5 Torr to form an intermediate stacked gate dielectric 20′.

Plasma Reoxidation Process 18

As shown in FIG. 4, the plasma nitrided intermediate stacked gate dielectric 20′ is subjected to a plasma reoxidation process 18 in the presence of preferably either O₂, N₂O or NO and more preferably O₂ at a temperature of preferably from about 300 to 700° C. and more preferably from about 350 to 650° C., and at a pressure of preferably from about 10 mTorr to 10 Torr and more preferably from about 20 mTorr to 5 Torr to form a final stacked gate dielectric 20″.

Plasma nitridation process 16 and plasma reoxidation process 18 may have the same process temperatures, as noted above. Compared with other annealing processes having a temperature greater than 800° C., the plasma processes 16, 18 each have a lower temperature, i.e. less than about 700° C., for a much shorter process time. Thus, the thermal budget is much reduced.

It is noted that reduced hydrogen content indicates improvement of the gate oxide reliability.

Electrical Performance of the Final Stacked Gate Dielectric 20″

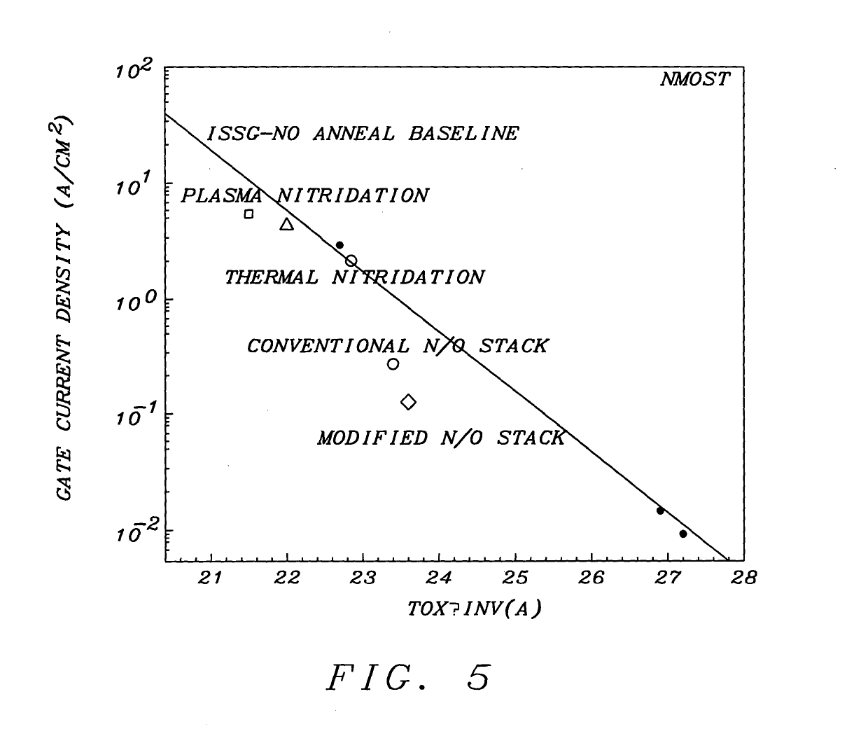

FIG. 5 is a graph of gate current density (A/cm²) versus Tox_inv (A) (i.e., the effective oxide thickness in inversion) where:
ISSG=In-situ Steam Generation—an approach to grow wet oxide in a single wafer chamber;
the “plasma nitridation” datum point represents “thermal oxide with plasma nitridation,” i.e. no nitride deposition;
the “thermal nitridation” datum point represents a thermal oxide with thermal nitridation, e.g. NH₃ nitridation;
the “convention N/O stack” datum point indicates the electrical performance of a completed conventional stacked gate dielectric;
the “modified N/O stack” datum point indicates the electrical performance of a completed final stacked gate dielectric 20″ made in accordance with the method of the present invention; and
“NMOST” is N-channel metal-oxide semiconductor transistor.
   Advantages of the Present Invention

The advantages of one or more embodiments of the present invention include:
1. significant reduction in thermal budget;
2. confinement of substrate implant due to much reduction in the thermal budget;
3. reduced hydrogen content in the nitride layer by using N₂ in the plasma nitridation process 16;
4. simplified overall process by eliminating temperature ramp-up and ramp-down step;
5. the throughput is enhanced; and
6. plasma processes are much more effective than convention thermal processes.

While particular embodiments of the present invention have been illustrated and described, it is not intended to limit the invention, except as defined by the following claims.

1. A method of forming a final stacked gate dielectric, comprising the steps of:
providing a substrate;
forming an oxide layer upon the substrate;
forming a nitride layer upon the oxide layer; the oxide layer and the nitride layer comprising an initial stacked gate dielectric;
subjecting the initial stacked gate dielectric to a plasma nitridation process under an N-containing ambient to form an intermediate stacked gate dielectric; and
subjecting the intermediate stacked gate dielectric to a plasma reoxidation process to form the final stacked gate dielectric.

2. The method of claim 1, wherein the oxide layer has a thickness of from about 3 to 15 Å and the nitride layer has a thickness of from about 5 to 30 Å.

3. The method of claim 1, wherein the oxide layer has a thickness of from about 5 to 10 Å and the nitride layer has a thickness of from about 5 to 15 Å.

4. The method of claim 1, wherein the oxide layer is thermal silicon oxide formed at a temperature of from about 600 to 700° C. and the nitride layer is formed at a temperature of from about 500 to 700° C.

5. The method of claim 1, wherein the oxide layer is thermal silicon oxide formed at a temperature of from about 625 to 675° C. and the nitride layer is formed at a temperature of from about 550 to 650° C.

6. The method of claim 1, wherein the oxide layer is thermal silicon oxynitride formed at a temperature of from about 700 to 900° C. and the nitride layer is formed at a temperature of from about 500 to 700° C.

7. The method of claim 1, wherein the oxide layer is thermal silicon oxynitride formed at a temperature of from about 750 to 850° C. and the nitride layer is formed at a temperature of from about 550 to 650° C.

8. The method of claim 1, wherein the oxide layer is thermal silicon oxide or thermal silicon oxynitride.

9. The method of claim 1, wherein the nitride layer is silicon nitride.

10. The method of claim 1, wherein the nitride layer is a CVD nitride layer.

11. The method of claim 1, wherein the nitride layer is formed by an RTCVD process or a RPECVD process.

12. The method of claim 1, wherein the plasma nitridation process is conducted at a temperature of from about 300 to 700° C.

13. The method of claim 1, wherein the plasma nitridation process is conducted at a temperature of from about 350 to 650° C.

14. The method of claim 1, wherein the plasma nitridation process is conducted under the following conditions:
temperature: from about 300 to 700° C.; and
pressure: from about 10 mTorr to 10 Torr.

15. The method of claim 1, wherein the plasma nitridation process is conducted under the following conditions:
temperature: from about 350 to 650° C.; and
pressure: from about 20 mTorr to 5 Torr.

16. The method of claim 1, wherein the plasma reoxidation process is conducted at a temperature of from about 300 to 700° C.

17. The method of claim 1, wherein the plasma reoxidation process is conducted at a temperature of from about 350 to 650° C.

18. The method of claim 1, wherein the plasma reoxidation process is conducted under the following conditions:
temperature: from about 300 to 700° C.; and
pressure: from about 10 mTorr to 10 Torr.

19. The method of claim 1, wherein the plasma reoxidation process is conducted under the following conditions:
temperature: from about 350 to 650° C.; and
pressure: from about 20 mTorr to 5 Torr.

20. The method of claim 1, wherein the plasma reoxidation process 18 is conducted in the presence of a material selected from the group consisting of O₂, N₂O and NO.

21. The method of claim 1, wherein the plasma reoxidation process is conducted in the presence of O₂.

22. The method of claim 1, wherein the substrate is a silicon substrate.

23. A method of forming a final stacked gate dielectric, comprising the steps of:
providing a silicon substrate;
forming a thermal oxide layer upon the silicon substrate;
forming a nitride layer upon the thermal oxide layer; the thermal oxide layer and the nitride layer comprising an initial stacked gate dielectric;
subjecting the initial stacked gate dielectric to a plasma nitridation process under an N-containing ambient to form an intermediate stacked gate dielectric; and
subjecting the intermediate stacked gate dielectric to a plasma reoxidation process to form the final stacked gate dielectric.

24. The method of claim 23, wherein the thermal oxide layer has a thickness of from about 3 to 15 Å and the nitride layer has a thickness of from about 5 to 30 Å.

25. The method of claim 23, wherein the thermal oxide layer has a thickness of from about 5 to 10 Å and the nitride layer has a thickness of from about 5 to 15 Å.

26. The method of claim 23, wherein the thermal oxide layer is comprised of thermal silicon oxide formed using a temperature of from about 600 to 700° C. and the nitride layer is formed using a temperature of from about 500 to 700° C.

27. The method of claim 23, wherein the thermal oxide layer is comprised of thermal silicon oxide formed using a temperature of from about 625 to 675° C. and the nitride layer is formed using a temperature of from about 550 to 650° C.

28. The method of claim 23, wherein the thermal oxide layer is comprised of thermal silicon oxynitride formed using a temperature of from about 700 to 900° C. and the nitride layer is formed using a temperature of from about 500 to 700° C.

29. The method of claim 23, wherein the thermal oxide layer is comprised of thermal silicon oxynitride formed using a temperature of from about 750 to 850° C. and the nitride layer is formed using a temperature of from about 550 to 650° C.

30. The method of claim 23, wherein the thermal oxide layer is comprised of thermal silicon oxide or thermal silicon oxynitride.

31. The method of claim 23, wherein the nitride layer is comprised of silicon nitride.

32. The method of claim 23, wherein the nitride layer is a CVD nitride layer.

33. The method of claim 23, wherein the nitride layer is formed using an RTCVD process or a RPECVD process.

34. The method of claim 23, wherein the plasma nitridation process is conducted at a temperature of from about 300 to 700° C.

35. The method of claim 23, wherein the plasma nitridation process is conducted at a temperature of from about 350 to 650° C.

36. The method of claim 23, wherein the plasma nitridation process is conducted under the following conditions:
temperature: from about 300 to 700° C.; and
pressure: from about 10 mTorr to 10 Torr.

37. The method of claim 23, wherein the plasma nitridation process is conducted under the following conditions:
temperature: from about 350 to 650° C.; and
pressure: from about 20 mTorr to 5 Torr.

38. The method of claim 23, wherein the plasma reoxidation process is conducted at a temperature of from about 300 to 700° C.

39. The method of claim 23, wherein the plasma reoxidation process is conducted at a temperature of from about 350 to 650° C.

40. The method of claim 23, wherein the plasma reoxidation process is conducted under the following conditions:
temperature: from about 300 to 700° C.; and
pressure: from about 10 mTorr to 10 Torr.

41. The method of claim 23, wherein the plasma reoxidation process is conducted under the following conditions:
temperature: from about 350 to 650° C.; and
pressure: from about 20 mTorr to 5 Torr.

42. The method of claim 23, wherein the plasma reoxidation process 18 is conducted in the presence of a material selected from the group consisting of O₂, N₂O and NO.

43. The method of claim 23, wherein the plasma reoxidation process is conducted in the presence of O₂.
